(19) United States
(12) Patent Application Publication
(10) Pub. No.: US 2025/0165988 A1
(43) Pub. Date: May 22, 2025

(54) SEARCH DEVICE AND PROGRAM

(71) Applicant: Masayuki SHOBAYASHI, Tokyo (JP)

(72) Inventor: Takuya SAITO, Tokyo (JP)

(73) Assignee: Masayuki SHOBAYASHI, Tokyo (JP)

(21) Appl. No.: 18/861,838

(22) PCT Filed: Apr. 27, 2023
(86) PCT No.: PCT/JP2023/016717

§ 371 Date: Dec. 4, 2024

(30) Foreign Application Priority Data
May 2, 2022 (JP) 2022-075830

(51) Int. Cl. G06Q 30/018

(52) U.S. Cl. CPC G06Q 30/018

(57) ABSTRACT

The present invention addresses the problem of providing a search device and a program capable of obtaining multifaceted information about business of a candidate predecessor company wishing to transfer business. Provided is a search device 1 for searching for business of a candidate predecessor company wishing transfer of business, the search device 1 comprising: a query reception unit 14 that receives a search query for information on predetermined business from a prospective buyer company wishing predetermined acquisition; a search execution unit 15 that searches for detailed information indicating details of target business to be succeeded, evaluation information indicating an evaluation of the detailed information by a third party, and customer information indicating a potential customer of a product of the business to be succeeded, the search being executed on the basis of the received search query; and an output unit 17 that outputs a search result. The problem is solved thereby.

### TECHNICAL FIELD

The present invention relates to a search device and a program.

### BACKGROUND ART

Business succession from a company to a company has been known. The business succession can bring advantages, such as resolution of lack of a successor, continuation of the business, and the like to the seller. In addition, the business succession can bring advantages, such as an increase in sales scale, an increase in share, and the like to the buyer. As a system for such business succession, a business succession support system has been proposed in which a predecessor company and a successor company are matched with each other based on predecessor company information regarding the predecessor company and successor company information regarding the successor company (see, for example, Patent Document 1).

### CITATION LIST

### Patent Document

Patent Document 1: Japanese Unexamined Patent Application, Publication No. 2020-71551

### DISCLOSURE OF THE INVENTION

### Problems to be Solved by the Invention

In order to increase the value of business succession, it is favorable that information including advice about the business succession can be obtained with respect to a business of a predecessor company that wishes the business to be succeeded to by way of business succession.

An object of the present invention is to provide a search device and a program that enable obtaining information including advice about business succession with respect to a business of a candidate predecessor company that wishes the business to be succeeded to by way of business succession.

### Means for Solving the Problems

The present invention relates to a search device for searching for a business of a candidate predecessor company that wishes the business to be succeeded to by way of business succession. The search device includes: a query reception unit that receives, from a prospective buyer company that wishes to buy a predetermined business, information regarding the predetermined business as a search query; a search execution unit that searches for, based on the search query, detailed information indicating details of the business of the candidate predecessor company, evaluation information indicating an evaluation of the detailed information by a third party, and customer information indicating a potential customer who is likely to purchase a product related to the business of the candidate predecessor company; and an output unit that outputs a search result.

Preferably, the output unit outputs the search result and information regarding the search result to the prospective buyer company by using a predetermined algorithm that is based on natural language processing.

Preferably, the search device further includes: a company identification information reception unit that receives, from the prospective buyer company, information for identifying the prospective buyer company as company identification information; a request reception unit that receives, from the prospective buyer company, a request for disclosure of other undisclosed information included in the evaluation information; a notification unit that notifies the company identification information to the third party, who is an evaluator of the evaluation information; a third party identification information reception unit that receives, from the third party, information for identifying the third party and a request for interaction with the prospective buyer company that has made the request as third party identification information, in response to notification of the company identification information; and an access permission unit that gives, based on reception of the third party identification information, access permission for the prospective buyer company to access the other undisclosed information included in the evaluation information for which the request has been made, permission for disclosure of the company identification information and the third party identification information between the prospective buyer company and the third party, and permission for the prospective buyer company and the third party to interact with each other. The notification unit preferably notifies contents permitted by the access permission unit to the prospective buyer company and the third party.

Preferably, the search device further includes a ranking execution unit that ranks businesses of a plurality of the candidate predecessor companies based on the evaluation information, and the output unit outputs ranking of the businesses of the candidate predecessor companies.

Preferably, the output unit outputs, based on the access permission, the evaluation information including a state of a discrepancy between scope of the business of the candidate predecessor company and scope of the business of the candidate predecessor company protected by an intellectual property right, and a proposal for resolving the discrepancy.

Preferably, the output unit outputs the customer information including a list of new candidate customers derived from a citation map.

Preferably, the output unit outputs the evaluation information including information regarding post merger integration (PMI).

Preferably, the output unit outputs detailed information including a feature keyword of the business of the candidate predecessor company and summary information regarding a patent related to the business of the candidate predecessor company.

Preferably, the output unit outputs the customer information including information for identifying the customer, based on the access permission.

Preferably, the output unit outputs evaluation information including a point to note and a suggestion for PMI, based on the access permission.

Preferably, the search device further includes an evaluation reception unit that receives an evaluation of the business of the candidate predecessor company by a new third party, and the notification unit outputs the evaluation information including the evaluation of the business of the candidate predecessor company by the third party to the new third party that has anew made the evaluation.

Furthermore, the present invention relates to a computer program for causing a computer to function as a search device that searches for a business of a candidate predecessor company that wishes the business to be succeeded to by way of business succession. The program causes the computer to function as units including: a query reception unit that receives, from a prospective buyer company that wishes to buy a predetermined business, information regarding the predetermined business as a search query; a search execution unit that searches for, based on the search query, detailed information indicating details of the business of the candidate predecessor company, evaluation information indicating an evaluation of the detailed information by a third party, and customer information indicating a potential customer who is likely to purchase a product related to the business of the candidate predecessor company; and an output unit that outputs a search result.

### Effects of the Invention

The present invention can provide a search device and a program that enable obtaining multifaceted information including advice about business succession with respect to a business of a candidate predecessor company that wishes the business to be succeeded to by way of business succession.

### BRIEF DESCRIPTION OF THE DRAWINGS

FIG. 1 is a configuration diagram illustrating a network configuration including a search device according to an embodiment of the present invention;

FIG. 2 is a block diagram illustrating a configuration of the search device according to the embodiment;

FIG. 3 is a flowchart illustrating an operation flow of the search device according to the embodiment; and

FIG. 4 is a flowchart illustrating another operation flow of the search device according to the embodiment.

### PREFERRED MODE FOR CARRYING OUT THE INVENTION

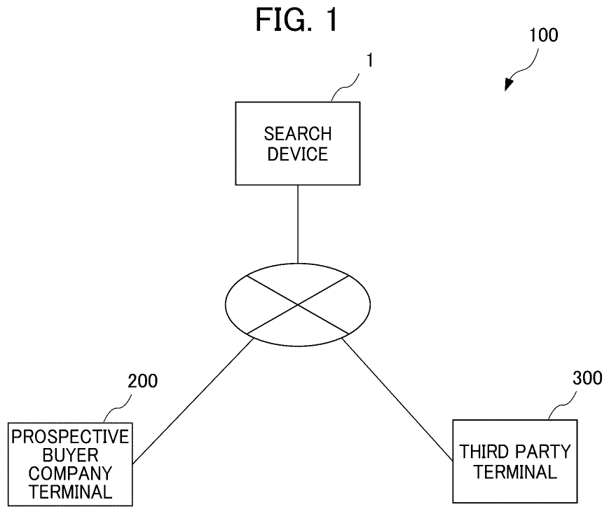

A search device 1 and a program according to an embodiment of the present invention will be described with reference to FIGS. 1 to 4. First, an overview of the search device 1 according to the embodiment is described, followed by a detailed description of the search device 1.

The search device 1 is, for example, a server. The search device 1 is, for example, a device capable of searching for a business of a candidate predecessor company that wishes the business to be succeeded to by way of business succession. The search device 1 receives a request for search for a predetermined business from a prospective buyer company that wishes to buy a business of a candidate predecessor company, and outputs a result of the search. The result outputted from the search device 1 includes advice about the predetermined business. The result outputted from the search device 1 includes an evaluation of the predetermined business by a third party (e.g., an expert such as a patent attorney, a certified consultant, etc.). In this way, the search device 1 contributes to an increase in the value of business succession.

Next, a search system 100 including the search device 1 will be described. As illustrated in FIG. 1, the search system 100 includes the search device 1, a prospective buyer company terminal 200, and a third party terminal 300.

The search device 1 is connected to the prospective buyer company terminal 200 and the third party terminal 300 via a network N. Details of the search device 1 will be described later.

The prospective buyer company terminal 200 is, for example, an information communication terminal such as a PC, a smartphone, or the like. The prospective buyer company terminal 200 is used by a company that wishes to buy a predetermined business.

The third party terminal 300 is, for example, an information communication terminal such as a PC, a smartphone, or the like. The third party terminal 120 is used by an expert who posts a review about a business of a candidate predecessor company.

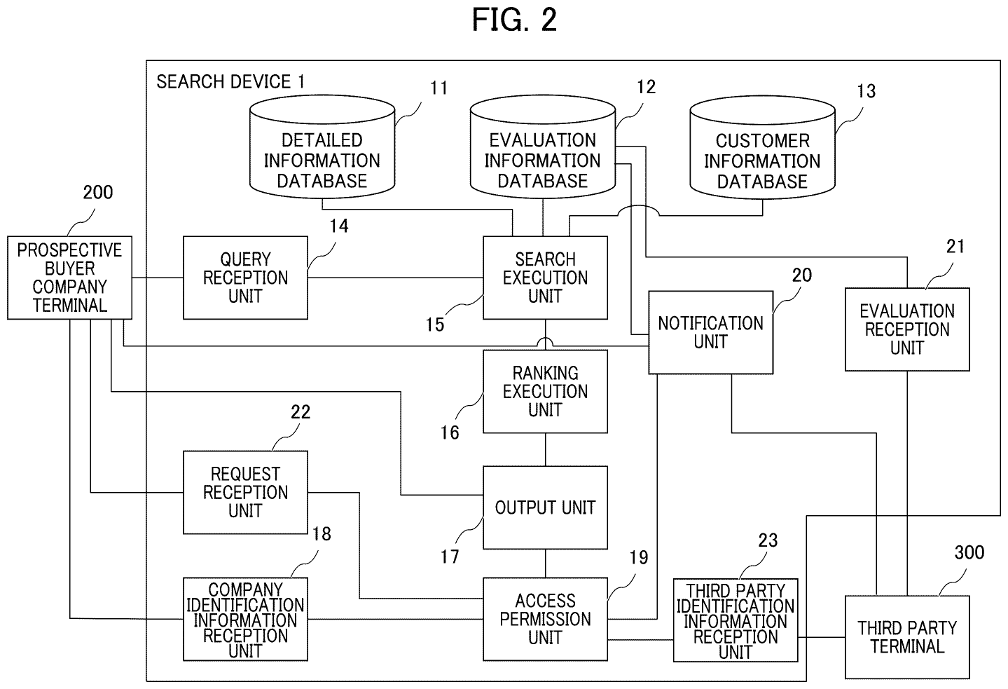

Next, the search device 1 of the present embodiment will be described with reference to FIG. 2. The search device 1 searches for a business of a candidate predecessor company that wishes the business to be succeeded to by way of business succession. As illustrated in FIG. 2, the search device 1 includes a detailed information database 11, an evaluation information database 12, a customer information database 13, a query reception unit 14, a search execution unit 15, a ranking execution unit 16, an output unit 17, a company identification information reception unit 18, a request reception unit 22, a notification unit 20, a third party identification information reception unit 23, an access permission unit 19, and an evaluation reception unit 21.

The detailed information database 11 is maintained in an area of a storage medium such as a hard disk or a memory, for example. The detailed information database 11 stores therein detailed information indicating details of businesses of candidate predecessor companies. The detailed information database 11 stores therein the detailed information including, for example, the name of each candidate predecessor company that wishes a business thereof to be succeeded to by way of business succession, the contents of the business of the candidate predecessor company, intellectual property rights related to the business of each candidate predecessor company, etc. The detailed information database 11 stores therein a patent related to a predetermined business, a customer who purchases a product, details of the business of the candidate predecessor company, etc. as the detailed information.

For example, the information is registered in the detailed information database 11 in the following manner. A candidate predecessor company has a business, and wishes the business to be succeeded to by a prospective buyer company. In this case, the candidate predecessor company usually consults a financial channel with which the candidate predecessor company has dealings. In response, the financial channel introduces a service to which the present invention is applied (hereinafter referred to as “the present service”) to the candidate predecessor company. The candidate predecessor company then registers, in the detailed information database 11, information regarding details of the business of interest, information regarding intellectual property rights including a patent application and a patent, and the like.

The evaluation information database 12 is maintained in an area of a storage medium such as a hard disk or a memory, for example. The evaluation information database 12 stores therein evaluation information indicating an evaluation of the detailed information by a third party. The evaluation information database 12 stores therein an evaluation by an expert (e.g., a patent attorney, a certified consultant, etc.), who is a third party, as the evaluation information. The evaluation information database 12 stores, for example, the evaluation information associated with the detailed information. Furthermore, the evaluation information database 12 stores, as the evaluation information, a state of a discrepancy between scope of the business of the candidate predecessor company and scope of the business of the candidate predecessor company protected by the intellectual property rights, and a proposal for resolving the discrepancy. The evaluation information database 12 stores the evaluation information including a list of new candidate customers derived from a citation map. The evaluation information database 12 stores the evaluation information including information (areas of concern and areas for improvement) related to post merger integration (PMI). The evaluation information database 12 stores detailed information including a feature keyword of the business of the candidate predecessor company and summary information regarding a patent related to the business of the candidate predecessor company. The evaluation information database 12 stores the evaluation information including a point to note and a suggestion for the PMI. Furthermore, the evaluation information database 12 stores, as the evaluation information, a management design sheet with respect to the detailed information and information regarding a local benchmark.

For example, the information is registered in the evaluation information database 12 in the following manner. In the present service, an expert such as a patent attorney, a certified consultant, or the like as a third party conducts an on-site hearing with the candidate predecessor company, intellectual property surveys, market research, and the like based on the information registered in the detailed information database 11 by the candidate predecessor company, and thereby creates the above-described evaluation information and the like and registers the evaluation information and the like in the evaluation information database 12. At this time, the information registered in the evaluation information database 12 includes disclosed information and confidential information.

The customer information database 13 is maintained in an area of a storage medium such as a hard disk or a memory, for example. The customer information database 13 stores therein customer information indicating a potential customer who is likely to purchase a product of the business of the candidate predecessor company. The customer information database 13 stores, for example, the customer information indicating a new potential customer who is likely to purchase a product produced by the business of the candidate predecessor company. The customer information database 13 stores, for example, the customer information associated with the detailed information and the evaluation information. The customer information database 13 stores the customer information including the company name of a customer.

For example, the information is registered in the customer information database 13 in the following manner. In the present service, the candidate predecessor company registers, in the customer information database 13, information regarding details of the business of interest, information regarding intellectual property rights including a patent application and a patent, and the like. In addition, for example, an expert such as a patent attorney, a certified consultant, or the like as a third party may register the customer information indicating a potential customer who is likely to purchase a product of the business of the candidate predecessor company. Alternatively, for example, the server 1 generates customer information indicating a potential customer who is likely to purchase a product of the business of the candidate predecessor company based on the information in the detailed information database 11 and the information in the evaluation information database 12, and stores the generated customer information in the customer information database 13. Specifically, for example, based on the information in the detailed information database 11 and the information in the evaluation information database 12, the server 1 can derive the customer information indicating a potential customer who is likely to purchase a product of the business of the candidate predecessor company from the relevance between the industry, the type of business, citation of the intellectual properties, and the like, and can store the derived customer information in the customer information database 13.

The query reception unit 14 is implemented by, for example, operating a CPU. The query reception unit 14 receives, from a prospective buyer company that wishes to buy a predetermined business, information regarding the predetermined business as a search query. The query reception unit 14 receives, as the search query, contents of the predetermined business that the prospective buyer company wishes to buy and contents related to the field to which the predetermined business belongs, which are transmitted from the prospective buyer company terminal 200. Furthermore, the query reception unit 14 receives, from the third party terminal 300, information regarding a new evaluation of the predetermined business by a third party as a search query.

The search execution unit 15 is implemented by, for example, operating the CPU. Based on the search query, the search execution unit 15 searches for detailed information indicating the details of a business of a candidate predecessor company, evaluation information indicating an evaluation of the detailed information by a third party, and customer information indicating a potential customer who is likely to purchase a product related to the business of the candidate predecessor company. For example, the search execution unit 15 searches the detailed information database 11 for detailed information matching the search query. The search execution unit 15 reads the detailed information, the evaluation information, and the customer information that match the search result, from the detailed information database 11, the evaluation information database 12, and the customer information database 13.

The ranking execution unit 16 is implemented by, for example, operating the CPU. The ranking execution unit 16 ranks the businesses of the candidate predecessor companies based on the evaluation information. For example, the ranking execution unit 16 ranks the businesses of the candidate predecessor companies according to how large or small the number of evaluations (evaluation reports) by the third parties is.

Specifically, in a case where a candidate predecessor company is receiving attention, the number of evaluations (evaluation reports) by the third parties is considered to increase. Therefore, by ranking the businesses of the candidate predecessor companies according to the numbers of evaluations (evaluation reports) by the third parties, a candidate predecessor company that has received attention so far is placed in a higher rank. Furthermore, for example, the ranking execution unit 16 may rank the businesses of the candidate predecessor companies according to levels at which they are assessed in the evaluations (evaluation reports) by the third parties. Ranking the businesses of the candidate predecessor companies according to the levels at which they are assessed in the evaluations (evaluation reports) by the third parties allows a candidate predecessor company having a high assessment result in the evaluations (evaluation reports) to be placed in a higher rank. The ranking execution unit 16 may rank the businesses of the candidate predecessor companies according to a comprehensive index that is derived in consideration of both the number of evaluations (evaluation reports) and an assessment result by the third parties.

The output unit 17 is implemented by, for example, operating the CPU. The output unit 17 outputs a search result. For example, the output unit 17 outputs a search result to the prospective buyer company terminal 200 that has transmitted a search query. For example, the output unit 17 outputs, as the search result, evaluation information regarding other undisclosed information included in the evaluation information. The output unit 17 outputs, for example, information indicating the presence or absence of the evaluation information and the presence or absence of the ranking. The output unit 17 outputs, for example, information indicating the presence or absence of the customer information.

Specifically, the output unit 17 can output a search result indicating ranking of the candidate predecessor companies. Thus, the ranking in consideration of the evaluations (evaluation reports) by the third parties allows a prospective buyer company to more efficiently analyze the candidate predecessor companies.

Here, the output unit 17 can use an artificial intelligence program based on natural language processing (hereinafter referred to as “AI”, which specifically includes, for example, an open-domain question-and-answer technology) to converse in natural language like humans, and can also output various information in the form of answers to questions about specific topics. Specifically, for example, the output unit 17 can output a search result in a sentence format such as “ . . . would be recommended”, in addition to a simple ranking format such as a table. In this case, if a responsible person of a prospective buyer company sends a reply that “in relation to the field of electronics, please advise us of the power semiconductor-related business, in particular”, the AI of the output unit 17 performs processing so as to select information from the search results and execute a search and ranking again by changing the search query. As a result, the AI of the output unit 17 can output a search result and the like in the form of conversation with the responsible person of the prospective buyer company.

For example, there may be a case where a responsible person of a prospective buyer company is not an expert such as a patent attorney, a certified consultant, or the like, and cannot understand the contents of an evaluation report. In this case, the responsible person can send a reply saying “please tell me how to read the graph in the evaluation report”, and in response, the AI can provide, for example, an explanation about the graph. Specifically, for example, the output unit 17 can use the AI to make a reply saying “this graph is generally prepared for the purpose of checking scope protected by a patent, . . . and it can be construed from this graph that the candidate predecessor company holds a patent directed to an approach of solving the problem by a method B instead of a method A”. As described above, since the output unit 17 can provide outputs by using the AI, a responsible person of a prospective buyer company can browse and analyze an evaluation (evaluation report) made by a third party as if the third party is explaining the evaluation (evaluation report) to her/him. However, at this stage, the prospective buyer company can browse and analyze only the disclosed information among the evaluations (evaluation reports) by the third parties. In order for the prospective buyer company to browse confidential information included in the information registered in the evaluation information database 12, the following access permission or the like is required.

The company identification information reception unit 18 is implemented by, for example, operating the CPU. The company identification information reception unit 18 receives, from a prospective buyer company, information for identifying the prospective buyer company as company identification information. For example, the company identification information reception unit 18 receives, as the company identification information, the company name of the prospective buyer company. For example, the company identification information reception unit 18 receives, as the company identification information, a contact address of the prospective buyer company. For example, the company identification information reception unit 18 receives the company name of the prospective buyer company transmitted from the prospective buyer company terminal 200.

The request reception unit 22 is implemented by, for example, operating the CPU. The request reception unit 22 receives, from the prospective buyer company, a request for disclosure of other undisclosed information included in the evaluation information. For example, the request reception unit 22 receives, from the prospective buyer company terminal 200, a request for disclosure of a part of the confidential information included in the evaluation information. The request reception unit 22 receives, for example, a request for disclosure of detailed contents related to an evaluation of the detailed information by a third party, as a part of the confidential information.

The notification unit 20 is implemented by, for example, operating the CPU. The notification unit 20 notifies the company identification information to the third party, who is the evaluator of the evaluation information. For example, the notification unit 20 notifies the third party as the evaluator of the detailed information (e.g., the third party terminal 300) of the name of a company to whom access permission has been granted. In addition, the notification unit 20 outputs evaluation information, which is received by the evaluation reception unit 21 (to be described later) and includes the evaluation of the business of the candidate predecessor company by the third party, to a third party who has newly made an evaluation.

The third party identification information reception unit 23 is implemented by, for example, operating the CPU. In response to the notification of the company identification information, the third party identification information reception unit 23 receives, from the third party, information for identifying the third party and a request for interaction with the prospective buyer company that has made the request, as third party identification information. For example, the third party identification information reception unit 23 receives the third party identification information including the name of the third party from the third party terminal 300. For example, the third party identification information reception unit 23 receives the third party identification information including a contact address of the third party from the third party terminal 300.

The access permission unit 19 is implemented by, for example, operating the CPU. Based on the reception of the third party identification information, the access permission unit 19 gives access permission for the prospective buyer company to access the other undisclosed information included in the evaluation information for which the request has been made, permission for disclosure of the company identification information and the third party identification information between the prospective buyer company and the third party, and permission for the prospective buyer company and the third party to interact with each other. For example, the access permission unit 19 permits the prospective buyer company to access some confidential evaluation information, the details of the evaluation information, the ranking result, and the details of the customer information, based on the reception of the company identification information and the third party identification information. The access permission unit 19 permits the prospective buyer company and the third party to interact with each other by way of disclosure of the received company identification information and third party identification information to the prospective buyer company and the third party.

As described above, in order for a prospective buyer company to browse the confidential information included in the information registered in the evaluation information database 12, the prospective buyer company and a third party (e.g., an expert such as a patent attorney, a certified consultant, or the like) interact with each other on the condition that a request for browsing the confidential information has been made and the real names of the both are disclosed and under the duty of confidentiality. As a result, the prospective buyer company can obtain the confidential information included in the information registered in the evaluation information database 12 and receive a detailed explanation by the third party who made the evaluation. From the viewpoint of the expert as the third party, by creating and registering an evaluation report that is attractive to prospective buyer companies, the expert can appeal their ability to the prospective buyer companies and encourage the prospective buyer companies to disclose their real names for the purpose of browsing the confidential information. In addition, for example, the prospective buyer company and the third party can interactively explain risk information regarding implementation of an invention, such as know-how other than a patent to be transferred, whereby they can make a decision as to whether to transfer only the patent, the patent and know-how, or the businesses.

The evaluation reception unit 21 is implemented by, for example, operating the CPU. The evaluation reception unit 21 receives an evaluation of a business of a candidate predecessor company by a new third party. For example, the evaluation reception unit 21 receives a new evaluation of a search result that is based on a search query transmitted from the third party terminal 300. The evaluation reception unit 21 stores evaluation information including the new evaluation in the evaluation information database 12.

The access permission unit 19, the notification unit 20, and the output unit 17 described above cooperate in the following way. The notification unit 20 notifies the contents permitted by the access permission unit 19 to the prospective buyer company (the prospective buyer company terminal 200) and the third party (the third party terminal 300). Based on the access permission, the output unit 17 outputs evaluation information including other undisclosed information for which a request has been made to the prospective buyer company terminal 200. Based on the access permission, the output unit 17 outputs ranking of the businesses of the candidate predecessor companies to the prospective buyer company terminal 200. Based on the access permission, the output unit 17 outputs the evaluation information including a state of a discrepancy between the scope of the business of the candidate predecessor company and scope of the business of the candidate predecessor company protected by an intellectual property right, and a proposal for resolving the discrepancy. The output unit 17 outputs evaluation information including a list of new candidate customers derived from a citation map. The output unit 17 outputs evaluation information including information regarding post merger integration (PMI). The output unit 17 outputs detailed information including a feature keyword of the business of the candidate predecessor company and summary information of a patent related to the business of the candidate predecessor company. The output unit 17 outputs customer information including the company name of a customer, based on the access permission. The output unit 17 outputs evaluation information including a point to note and a suggestion for the PMI, based on the access permission.

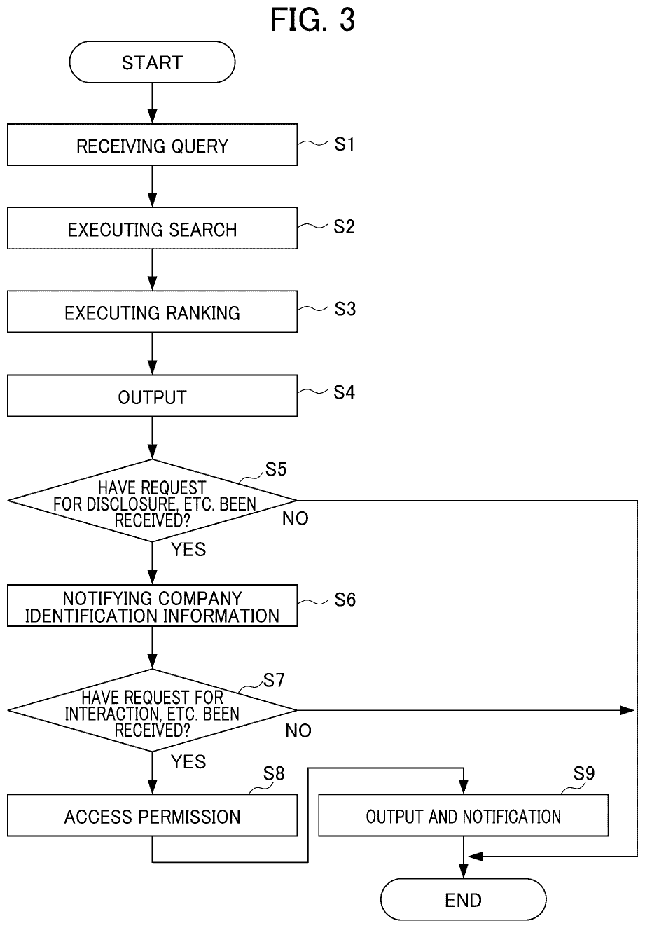

Next, a search operation by the search device 1 will be described with reference to the flowchart of FIG. 3. First, the query reception unit 14 receives a search query (Step S1). Next, the search execution unit 15 executes a search based on the received search query (Step S2). Next, the ranking execution unit 16 ranks the search results (Step S3). Next, the output unit 17 outputs the search results to the prospective buyer company terminal 200 (Step S4).

Next, it is determined whether or not company identification information and a request for disclosure of other undisclosed information included in the evaluation information have been received by the company identification information reception unit 18 (Step S5). When the company identification information has been received (YES in Step S5), the process proceeds to Step S6. On the other hand, when the company identification information has not been received (NO in Step S5), the process according to the present flow ends.

In Step S6, the notification unit 20 notifies the received company identification information to the evaluator of the evaluation information for which the request has been made. Next, it is determined whether or not third party identification information and a request for interaction have been received by the third party identification information reception unit 23 (Step S7).

When the third party identification information and a request for interaction have been received (YES in Step S7), the process proceeds to Step S8. On the other hand, when the third party identification information and a request for interaction have not been received (NO in Step S7), the process according to the present flow ends.

In Step S8, the access permission unit 19 permits the prospective buyer company to access the other undisclosed information included in the evaluation information, and permits the prospective buyer company and the third party to interact with each other. Next, the notification unit 20 notifies the prospective buyer company terminal 200 and the third party terminal 300 of the contents that have been permitted to be accessed (Step S9). In addition, the output unit 17 outputs the other undisclosed information included in the evaluation information, which has been permitted to be accessed, to the prospective buyer company terminal 200. Furthermore, the output unit 17 outputs: ranking of the businesses of the candidate predecessor companies; the evaluation information including a state of a discrepancy between the scope of the business of the candidate predecessor company and scope of the business of the candidate predecessor company protected by an intellectual property right, and a proposal for resolving the discrepancy; the evaluation information including a list of new candidate customers derived from a citation map; the evaluation information including information regarding the post merger integration (PMI); the detailed information including a feature keyword of the business of the candidate predecessor company and summary information regarding a patent related to the business of the candidate predecessor company; and the customer information including the company name of a customer. Based on the access permission, the output unit 17 outputs the evaluation information including a point to note and a suggestion for the PMI. Thus, the process according to the present flow ends.

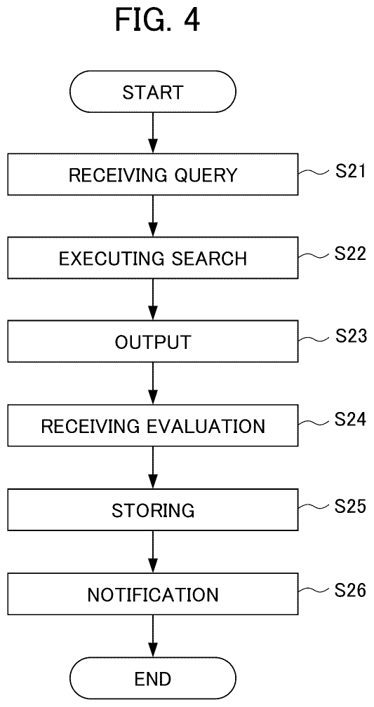

Next, a process in which the search device 1 obtains a new evaluation will be described with reference to the flowchart of FIG. 4. First, the query reception unit 14 receives a search query from a third party (third party terminal 300) that makes an evaluation (Step S21). Next, the search execution unit 15 executes a search based on the received search query (Step S22). Next, the output unit 17 outputs a search result to the third party terminal 300 (Step S23). Next, the evaluation reception unit 21 receives a new evaluation from the third party (Step S24). Next, the evaluation reception unit 21 stores the received new evaluation in the evaluation database (Step S25). Next, the notification unit 20 notifies a third party who has already made an evaluation on the candidate predecessor company's business, on which the new evaluation has been made, that the new evaluation has been made (Step S26). As a result, the processing according to the present flow ends.

Next, a program will be described. The components included in the search device 1 can be implemented by hardware, software, or a combination thereof. Here, the implementation by software means that a computer reads and executes a program for the implementation.

The program can be stored in various types of non-transitory computer readable media and can be provided to a computer. The non-transitory computer readable media include various types of tangible storage media. Examples of the non-transitory computer readable media include a magnetic recording medium (e.g., a flexible disk, a magnetic tape, a hard disk drive), a magnetic-optical recording medium (e.g., a magnetic optical disk), a read only memory (CD-ROM), a CD-R, a CD-R/W, and a semiconductor memory (e.g., a mask ROM, a programmable ROM (PROM), an erasable PROM (EPROM), a flash ROM, and a random access memory (RAM)). A display program may be provided to the computer by way of various types of transitory computer readable media. Examples of the transitory computer readable media include an electrical signal, an optical signal, and an electromagnetic wave. The transitory computer readable medium can provide a program to the computer through a wired communication line, such as a wire and an optical fiber, or through a wireless communication.

The search device 1 and the program according to the present embodiment described above exert the following effects.
(1) A search device 1 is for searching for a business of a candidate predecessor company that wishes the business to be succeeded to by way of business succession, and includes: a query reception unit 14 that receives, from a prospective buyer company that wishes to buy a predetermined business, information regarding the predetermined business as a search query; a search execution unit 15 that searches for, based on the search query, detailed information indicating details of the business of the candidate predecessor company, evaluation information indicating an evaluation of the detailed information by a third party, and customer information indicating a potential customer who is likely to purchase a product related to the business of the candidate predecessor company; and an output unit 17 that outputs a search result. This feature makes it possible to obtain information including advice on the business succession, in relation to the business of the candidate predecessor company that wishes the business to be succeeded to by way of business succession.
(2) The search device 1 further includes: a company identification information reception unit that receives, from the prospective buyer company, information for identifying the prospective buyer company as company identification information; a request reception unit 22 that receives, from the prospective buyer company, a request for disclosure of other undisclosed information included in the evaluation information; a notification unit that notifies the company identification information to the third party, who is an evaluator of the evaluation information; a third party identification information reception unit 23 that receives, from the third party, information for identifying the third party and a request for interaction with the prospective buyer company that has made the request as the third party identification information, in response to notification of the company identification information; and an access permission unit 19 that gives, based on reception of the third party identification information, access permission for the prospective buyer company to access the other undisclosed information included in the evaluation information for which the request has been made, permission for disclosure of the company identification information and the third party identification information between the prospective buyer company and the third party, and permission for the prospective buyer company and the third party to interact with each other. The notification unit 20 notifies the contents permitted by the access permission unit 19 to the prospective buyer company and the third party. Due to this feature, security of information can be improved by permitting the prospective buyer company that has disclosed the company identification information to access the detailed information, while maintaining confidentiality of business succession in general outputs. In addition, the interaction between the prospective buyer company and the third party can be permitted, thereby making it possible to promote the succession of the candidate predecessor company.
(3) The search device 1 further includes a ranking execution unit 16 that ranks businesses of a plurality of the candidate predecessor companies based on the evaluation information, and the output unit 17 outputs ranking of the businesses of the candidate predecessor companies. This feature makes it easy to become aware of an index indicating how high or low the business of the candidate predecessor company is evaluated by the third party.
(4) The output unit 17 outputs, based on the access permission, the evaluation information including a state of a discrepancy between the scope of the business of the candidate predecessor company and scope of the business of the candidate predecessor company protected by an intellectual property right, and a proposal for resolving the discrepancy. This feature makes it possible to easily see the promise of the business of the candidate predecessor company.
(5) The output unit 17 outputs the customer information including a list of new candidate customers derived from a citation map. This feature makes it possible to easily see the promise of the business of the candidate predecessor company.
(6) The output unit 17 outputs the evaluation information including information regarding post merger integration (PMI). This feature makes it possible to easily see the promise of the business of the candidate predecessor company.
(7) The output unit 17 outputs detailed information including a feature keyword of the business of the candidate predecessor company and summary information regarding a patent related to the business of the candidate predecessor company. This feature makes it possible to easily see the promise of the business of the candidate predecessor company.
(8) The output unit 17 outputs the customer information including information for identifying the customer, based on the permission for the access. This feature makes it possible to easily see the promise of the business of the candidate predecessor company.
(9) The output unit 17 outputs evaluation information including points to note and suggestions for the PMI, based on the access permission. This feature makes it possible to easily see the promise of the business of the candidate predecessor company.
(10) The search device 1 further includes an evaluation reception unit 21 that receives an evaluation of the business of the candidate predecessor company by a new third party, and the notification unit 20 outputs the evaluation information including the evaluation of the business of the candidate predecessor company by the third party to the new third party that has anew made the evaluation. This feature makes it possible for a plurality of the third parties to share the evaluation contents. Thus, it is possible to further add a new evaluation content based on another third party's evaluation as a precondition.

In the foregoing, preferred embodiments of the search device and the program of the present invention have been described. It should be noted that the present invention is not limited to the above-described embodiments and can be appropriately modified. For example, in the above-described embodiment, the prospective buyer company terminal 200 and the third party terminal 300 may be configured to be distinguishable from each other. For example, the search device 1 may distinguish the prospective buyer company terminal 200 and the third party terminal 300 from each other by identifying each of them. The search device 1 may allow the detailed information, the evaluation information, and the customer information to be browsed in response to access from the third party terminal 300.

In the above-described embodiment, it is described that a business of a candidate predecessor company is searched for, outputted, and subjected to similar processes. However, a predetermined unit may be adopted to define a “business” of a candidate predecessor company. Specifically, for example, the entire candidate predecessor company may be defined as the “business”. Alternatively, the present invention can be applied to a case where a predetermined unit, such as a type of business or a type of product of the candidate predecessor company, is defined as the “business”.

Furthermore, in the above-described embodiment, the output is provided using the artificial intelligence program based on natural language processing, but the artificial intelligence is a non-limiting example. It is sufficient that the natural language processing is executed using a predetermined algorithm. The artificial intelligence is an example of the predetermined algorithm.

### EXPLANATION OF REFERENCE NUMERALS

1: Search device
14: Query reception unit
15: Search execution unit
16: Ranking execution unit
17: Output unit
18: Company identification information reception unit
19: Access permission unit
20: Notification unit
21: Evaluation reception unit
22: Request reception unit
23: Third party identification information reception unit

1. A search device for searching for a business of a candidate predecessor company that wishes the business to be succeeded to by way of business succession, the search device comprising:
a query reception unit that receives, from a prospective buyer company that wishes to buy a predetermined business, information regarding the predetermined business as a search query;
a search execution unit that searches for, based on the search query, detailed information indicating details of the business of the candidate predecessor company, evaluation information indicating an evaluation of the detailed information by a third party, and customer information indicating a potential customer who is likely to purchase a product related to the business of the candidate predecessor company; and
an output unit that outputs a search result.

2. The search device according to claim 1, wherein
the output unit outputs the search result and information regarding the search result to the prospective buyer company by using a predetermined algorithm that is based on natural language processing.

3. The search device according to claim 1, further comprising:
a company identification information reception unit that receives, from the prospective buyer company, information for identifying the prospective buyer company as company identification information;
a request reception unit that receives, from the prospective buyer company, a request for disclosure of other undisclosed information included in the evaluation information;
a notification unit that notifies the company identification information to the third party, who is an evaluator of the evaluation information;
a third party identification information reception unit that receives, from the third party, information for identifying the third party and a request for interaction with the prospective buyer company who has made the request as third party identification information, in response to notification of the company identification information; and
an access permission unit that gives, based on reception of the third party identification information, access permission for the prospective buyer company to access the other undisclosed information included in the evaluation information for which the request has been made, permission for disclosure of the company identification information and the third party identification information between the prospective buyer company and the third party, and permission for the prospective buyer company and the third party to interact with each other, wherein
the notification unit notifies contents permitted by the access permission unit to the prospective buyer company and the third party.

4. The search device according to claim 3, further comprising:
a ranking execution unit that ranks businesses of a plurality of the candidate predecessor companies based on the evaluation information, wherein
the output unit outputs ranking of the businesses of the candidate predecessor companies.

5. The search device according to claim 3, wherein
the output unit outputs, based on the access permission, the evaluation information including a state of a discrepancy between scope of the business of the candidate predecessor company and scope of the business of the candidate predecessor company protected by an intellectual property right, and a proposal for resolving the discrepancy.

6. The search device according to claim 3, wherein
the output unit outputs the customer information including a list of new candidate customers derived from a citation map.

7. The search device according to claim 3, wherein
the output unit outputs the evaluation information including information regarding post merger integration (PMI).

8. The search device according to claim 3, wherein
the output unit outputs detailed information including a feature keyword of the business of the candidate predecessor company and summary information regarding a patent related to the business of the candidate predecessor company.

9. The search device according to claim 3, wherein
the output unit outputs the customer information including information for identifying the customer, based on the access permission.

10. The search device according to claim 3, wherein
the output unit outputs evaluation information including a point to note and a suggestion for PMI, based on the access permission.

11. The search device according to claim 1, further comprising:
an evaluation reception unit that receives an evaluation of the business of the candidate predecessor company by a new third party, wherein
the notification unit outputs the evaluation information including the evaluation of the business of the candidate predecessor company by the third party to the new third party that has anew made the evaluation.

12. A non-transitory computer readable medium storing a program for causing a computer to function as a search device that searches for a business of a candidate predecessor company that wishes the business to be succeeded to by way of business succession,
the program causing the computer to function as units that comprises:
a query reception unit that receives, from a prospective buyer company that wishes to buy a predetermined business, information regarding the predetermined business as a search query;
a search execution unit that searches for, based on the search query, detailed information indicating details of the business of the candidate predecessor company, evaluation information indicating an evaluation of the detailed information by a third party, and customer information indicating a potential customer who is likely to purchase a product related to the business of the candidate predecessor company; and
an output unit that outputs a search result.
